(19) United States
(12) Patent Application Publication
(10) Pub. No.: US 2019/0213216 A1
(43) Pub. Date: Jul. 11, 2019

(54) METHOD AND DEVICE FOR GENERATING ARTICLE

(71) Applicant: Baidu Online Network Technology (Beijing) Co., Ltd., Beijing (CN)

(72) Inventors: Wenbin WANG, Beijing (CN); Peng SHI, Beijing (CN); Guangfa WU, Beijing (CN)

(21) Appl. No.: 16/355,263

(22) Filed: Mar. 15, 2019

Related U.S. Application Data
(63) Continuation of application No. PCT/CN2017/102620, filed on Sep. 21, 2017.

(30) Foreign Application Priority Data
Mar. 31, 2017 (CN) 201710206961.1

(51) Int. Cl. G06F 16/9035; G06F 16/901; G06F 17/22; G06F 17/27; G06F 17/24

(52) U.S. Cl. CPC G06F 16/9035; G06F 16/901; G06F 17/24; G06F 17/2785; G06F 17/274; G06F 17/2241

(57) ABSTRACT

Disclosed are a method and device for generating an article. A specific embodiment of the method comprises: generating an article outline on the basis of an input article topic and any one of an outline model, an outline database established according to user behavior data of a corresponding article topic, and a manually set outline; extracting, from a pre-established material library, a material associated with the feature of the article outline; and inserting the extracted material into the article outline to obtain a generated article.

### CROSS-REFERENCE TO RELATED APPLICATIONS

This is a continuation of International Application PCT/CN2017/102620, with an international filing date of Sep. 21, 2017, which claims priority to Chinese Application No. 201710206961.1, filed on Mar. 31, 2017, the entire disclosure of which is hereby incorporated by reference in its entirety.

### TECHNICAL FIELD

The present disclosure relates to the field of computer technology, specifically to the field of computer network technology, and more specifically to a method and device for generating an article.

### BACKGROUND

At present, the method for generating an article by automated writing through a machine basically focuses on special topics of special fields. Typically, the article is generated using the technology of filling materials according to rules or a template. For example, an original article may be filtered and then directly quoted; or, the original article may be simply transformed and directly published; or, original articles may be combined in a certain order and an abstract extraction is performed; or, data may be organized and displayed through the template.

However, the article generated by the existing method for generating an article is relatively monotonous in form and content, due to the limitations of theme and method. In addition, the text may be unreasonable in logic, the grammatical style may be inconsistent, and the trace of machine writing is heavy.

### SUMMARY

The objective of the present disclosure is to propose an improved method and device for generating an article, to solve the technical problem mentioned in the above Background section.

In a first aspect, embodiments of the present disclosure provide a method for generating an article, including: generating an article outline based on an input article topic and at least one of: an outline model, an outline database established based on user behavior data corresponding to the article topic, or a manually set outline; extracting, from a pre-established material library, a material associated with a characteristic of the article outline; and inserting the extracted material into the article outline to obtain a generated article.

In some embodiments, the outline database established based on user behavior data corresponding to the article topic includes: retrieving subtopics around the article topic across an entire network, to establish a subtopic database; sorting the subtopics in the subtopic database according to a user's click sequence on the subtopics in the subtopic database and/or a semantic progression sequence of the subtopics in the subtopic database; eliminating subtopics in the subtopic database that do not meet a predetermined logic rule, to obtain subtopics meeting the predetermined logic rule; and defining the subtopics meeting the predetermined logic rule as outlines to obtain the outline database.

In some embodiments, the pre-established material library is established by: acquiring a characteristic of the material, where the material is obtained by filtering contents of existing articles according to a filtering rule and/or transforming the contents of the existing articles; and establishing an index structure based on the characteristic of the material, to obtain the material library.

In some embodiments, the method further includes: performing optimization processing on the generated article to obtain an optimized generated article, and the optimization processing including at least one of the following: polishing processing, inserting rich media data processing, or typesetting optimization processing.

In some embodiments, the polishing processing includes at least one of: unifying a grammatical style of the generated article; deleting statements inconsistent with preceding and succeeding statements; and replacing the statements inconsistent with preceding and succeeding statements.

In some embodiments, the inserting rich media data processing includes: extracting rich media data associated with a characteristic of the generated article from a pre-established resource library; and inserting the extracted rich media data into the generated article.

In some embodiments, the extracting rich media data associated with a characteristic of the generated article from a pre-established resource library includes: generating a candidate rich media list from the pre-established resource library by extracting rich media data based on at least one of: the article topic, the article outline, abstracts of paragraphs of the generated article, or keywords of the paragraphs of the generated article; and extracting the rich media data associated with the characteristic of the generated article from the candidate rich media list using quality filtering.

In some embodiments, the pre-established resource library is established by: acquiring a characteristic of the rich media data; and establishing an index structure based on the characteristic of the rich media data, to obtain the resource library.

In some embodiments, the quality filtering is performed according to at least one of: graphic and textual relevance, image resolution, image aspect ratio, image source authority, advertisement filtering strategy, anti-cheat filtering strategy, anti-vulgar filtering strategy or watermark filtering strategy.

In some embodiments, the method further includes: inputting the article topic and the article outline into a title model to obtain a title of the generated article.

In some embodiments, the method further includes: performing an attribute expansion on a core word in the title; and replacing and rewriting the core word in the title after the attribute expansion to obtain an updated title.

In a second aspect, the embodiments of the present disclosure provide a device for generating an article, including: an outline generation unit, configured to generate an article outline based on an input article topic and at least one of: an outline model, an outline database established based on user behavior data corresponding to the article topic, or a manually set outline; a material extraction unit, configured to extract, from a pre-established material library, a material associated with a characteristic of the article outline; and a material insertion unit, configured to insert the extracted material into the article outline to obtain a generated article.

In some embodiments, the outline database established based on user behavior data corresponding to the article topic in the outline generation unit includes: retrieving subtopics around the article topic across an entire network, to establish a subtopic database; sorting the subtopics in the subtopic database according to a user's click sequence on the subtopics in the subtopic database and/or a semantic progression sequence of the subtopics in the subtopic database; eliminating subtopics in the subtopic database that do not meet a predetermined logic rule, to obtain subtopics meeting the predetermined logic rule; and defining the subtopics meeting the predetermined logic rule as outlines to obtain the outline database.

In some embodiments, the pre-established material library in the material extraction unit is established by: acquiring a characteristic of the material, where the material is obtained by filtering contents of existing articles according to a filtering rule and/or transforming the contents of the existing articles; and establishing an index structure based on the characteristic of the material, to obtain the material library.

In some embodiments, the device further includes: an article optimization unit, configured to perform optimization processing on the generated article to obtain an optimized generated article, and the optimization processing including at least one of: polishing processing, inserting rich media data processing, or typesetting optimization processing.

In some embodiments, the polishing processing in the article optimization unit includes at least one of the following: unifying a grammatical style of the generated article; deleting statements inconsistent with preceding and succeeding statements; and replacing the statements inconsistent with preceding and succeeding statements.

In some embodiments, the inserting rich media data processing in the article optimization unit includes: extracting rich media data associated with a characteristic of the generated article from a pre-established resource library; and inserting the extracted rich media data into the generated article.

In some embodiments, the extracting rich media data associated with a characteristic of the generated article from a pre-established resource library in the article optimization unit includes: generating a candidate rich media list from the pre-established resource library by extracting rich media data based on at least one of: the article topic, the article outline, abstracts of paragraphs of the generated article, or keywords of the paragraphs of the generated article; and extracting the rich media data associated with the characteristic of the generated article from the candidate rich media list using quality filtering.

In some embodiments, the pre-established resource library in the article optimization unit is established by: acquiring a characteristic of the rich media data; and establishing an index structure based on the characteristic of the rich media data, to obtain the resource library.

In some embodiments, the quality filtering in the article optimization unit is performed according to at least one of: graphic and textual relevance, image resolution, image aspect ratio, image source authority, advertisement filtering strategy, anti-cheat filtering strategy, anti-vulgar filtering strategy or watermark filtering strategy.

In some embodiments, the device further includes: a title generation unit, configured to input the article topic and the article outline into a title model to obtain a title of the generated article.

In some embodiments, the device further includes: an attribute expansion unit, configured to perform an attribute expansion on a core word in the title; and a title updating unit, configured to replace and rewrite the core word in the title after the attribute expansion to obtain an updated title.

In a third aspect, the embodiments of the present disclosure provide a device, including: one or more processors; and a storage apparatus, for storing one or more programs, the one or more programs, when executed by the one or more processors, cause the one or more processors to implement the method for generating an article according to any one of the embodiments in the first aspect.

In a fourth aspect, the embodiments of the present disclosure provide a computer readable storage medium, storing a computer program thereon, the computer program, when executed by a processor, implements the method for generating an article according to any one of the embodiments in the first aspect.

The method and device for generating an article provided by the embodiments of the present disclosure first generate an article outline based on an input article topic and at least one of: an outline model, an outline database established based on user behavior data of a corresponding article topic, or a manually set outline, then extract, from a pre-established material library, a material associated with the characteristic of the article outline, and then insert the extracted material into the article outline to obtain a generated article. In the present embodiment, an outline can be generated based on an input article topic, the quality of the article outline is improved, and reasonable writing logic and rich form of the generated article are ensured. By inserting a material associated with the characteristic of the article outline based on the article outline, the content of the article is enriched, so that the generated article has reasonable logic and rich form and content.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is a schematic flowchart of an embodiment of a method for generating an article according to the present disclosure;

FIG. 2 is a schematic flowchart of another embodiment of the method for generating an article according to the present disclosure;

FIG. 3 is an exemplary application scenario of an embodiment of the method for generating an article to which the present disclosure is applied;

FIG. 4 is an exemplary structural diagram of an embodiment of a device for generating an article according to the present disclosure; and

FIG. 5 is a schematic structural diagram of a computer system adapted to implement a terminal device or server of the embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

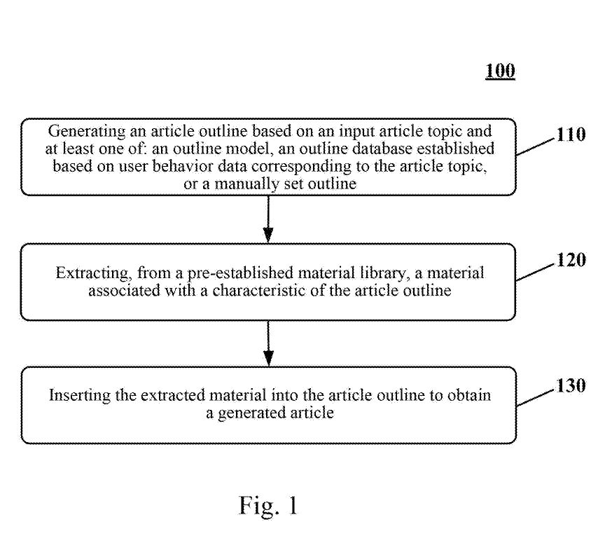

FIG. 1 illustrates a flow 100 of an embodiment of a method for generating an article according to the present disclosure. The method for generating an article include the following steps.

In step 110, generating an article outline based on an input article topic and at least one of: an outline model, an outline database established based on user behavior data corresponding to the article topic, or a manually set outline.

In the present embodiment, the input article topic may be a machine mined or a manually inputted article topic.

The outline model generally refers to a function with the article topic as the independent variable. First, the article model=f (topic, outline, material) may be set, that is, the article model is obtained from the independent variables (topic, outline, material) in the function f, and by using the article model, a method for generating an article may be obtained, that is, selecting the topic, mining and sorting the outlines using the outline model, and mounting the material using a material library, and finally obtaining the article through image matching, typesetting, and polishing.

The outline database established based on user behavior data corresponding to the article topic refers to determining an article directory from the perspective of the article topic, and sorting and filtering the article directory based on the user behavior data to obtain the outline database. It should be understood that the outline generated by an outline generation strategy here has a certain logical order to ensure the rationality of the text.

In some alternative implementations of the present embodiment, the outline database established based on user behavior data corresponding to the article topic includes: retrieving subtopics around the article topic across an entire network, to establish a subtopic database; sorting the subtopics in the subtopic database according to a user's click sequence on the subtopics in the subtopic database and/or a semantic progression sequence of the subtopics in the subtopic database; eliminating subtopics in the subtopic database that do not meet a predetermined logic rule, to obtain subtopics meeting the predetermined logic rule; and defining the subtopics meeting the predetermined logic rule as outlines to obtain the outline database.

In this implementation, the outline database established based on user behavior data corresponding to the article topic fully considers the user behavior data to establish outlines, which may improve the pertinence of the established outlines, thus enhancing the ability of interaction of the generated article with the user.

In step 120, extracting, from a pre-established material library, a material associated with a characteristic of the article outline.

In the present embodiment, the pre-established material library refers to a material library obtained by establishing an index structure based on the characteristic of the material. When the characteristic of the material is associated with the characteristic of the article outline, the material may be extracted for later use. When the characteristics of a plurality of materials are all associated with the characteristic of the article outline, a predetermined number of materials with most relevant characteristics to the characteristic of the article outline may be extracted from the plurality of materials for later use.

In some alternative implementations of the present embodiment, the pre-established material library is established by: acquiring a characteristic of the material, wherein the material is obtained by filtering contents of existing articles according to a filtering rule and/or transforming the contents of the existing articles; and establishing an index structure based on the characteristic of the material, to obtain the material library.

In this implementation, the generation of the material library includes material with a clear topic and material without a clear topic, and the latter needs to extract a topic using an article abstraction technology. Acquiring the characteristic of the material may be understood as extracting the characteristic from the text material. These characteristics may describe the topic, keyword, core semantics and other information of the text material, and are used for correlation calculation and sorting on the article outline and the article topic.

Specifically, the obtained by filtering according to a filtering rule may include filtering according to at least one of: the content length of the article, the content quality score of the article, the content satisfaction score of the article, the amount of viewing of the article, or the timeliness of the article. The transforming the contents of the existing articles is mainly to control the granularity of the material, and a predetermined rule may be used to complete the transformation. For example, a paragraph having a number of words greater than a predetermined value is disassembled and segmented. Assuming that a material is a raw corpus, after filtering, it may be sorted and combined according to the outline. Assuming that a material is a paragraph, it is required to consider the topic relevance of the paragraph, the sorting between paragraphs. Similarly, it is also possible to assume that the material is a sentence, a word, the smaller the granularity of the material, the more difficult it is to disassemble and/or transform the material.

In step 130, inserting the extracted material into the article outline to obtain a generated article.

In the present embodiment, the material extracted in step 120 may be inserted into the article outline obtained in step 110, to obtain the generated article.

The method for generating an article provided by the above embodiments of the present disclosure generates an article outline, extracts a material associated with the characteristic of the article outline, inserts the extracted material to obtain the generated article. The article outline may be generated based on the input article topic, and the material inserted into the article outline is extremely rich. Therefore, the generated article has reasonable logic, is rich in form and content, and close to articles written by professionals, thus abandoning the limitations of existing machine writing.

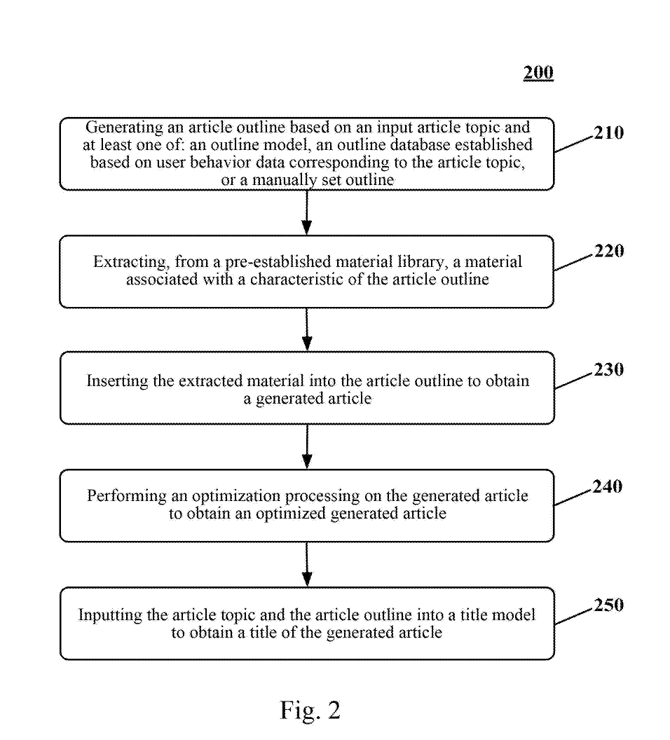

With further reference to FIG. 2, FIG. 2 illustrates a schematic flowchart of another embodiment of the method for generating an article according to the present disclosure. The method 200 for generating an article include the following steps.

In step 210, generating an article outline based on an input article topic and at least one of: an outline model, an outline database established based on user behavior data corresponding to the article topic, or a manually set outline.

In the present embodiment, the input article topic may be a machine mined or a manually inputted article topic.

The outline model generally refers to a function with the article topic as the independent variable. First, the article model=f (topic, outline, material) may be set, that is, the article model is obtained from the independent variables (topic, outline, material) in the function f, and by using the article model, a method for generating an article may be obtained, that is, selecting the topic, mining and sorting the outlines using the outline model, and mounting the material using a material library, and finally obtaining the article through image matching, typesetting, and polishing.

The outline database established based on user behavior data corresponding to the article topic refers to determining an article directory from the perspective of the article topic, and sorting and filtering the article directory based on the user behavior data to obtain the outline database. It should be understood that the outline generated by an outline generation strategy here has a certain logical order to ensure the rationality of the text.

In step 220, extracting, from a pre-established material library, a material associated with a characteristic of the article outline.

In the present embodiment, the pre-established material library refers to a material library obtained by establishing an index structure based on the characteristic of the material. When the characteristic of the material is associated with the characteristic of the article outline, the material may be extracted for later use. When the characteristics of a plurality of materials are all associated with the characteristic of the article outline, a predetermined number of materials with most relevant characteristics to the characteristic of the article outline may be extracted from the plurality of materials for later use.

In step 230, inserting the extracted material into the article outline to obtain a generated article.

In the present embodiment, the material extracted in step 220 may be inserted into the article outline obtained in step 210, to obtain the initially prototyped generated article.

In step 240, performing optimization processing on the generated article to obtain an optimized generated article.

In the present embodiment, the optimization processing includes at least one of: polishing processing, inserting rich media data processing, or typesetting optimization processing.

For the generated article, since there are materials of different grammatical styles in the material library, and the context connection may not be coherent, polishing processing may be performed on the generated article, that is, the grammatical style and statements of the article are processed. The grammar here is the writing regulations of the article, which is generally used to refer to complete statements compiled and composed of characters, words, short sentences and sentences, and the rational organization of the article. The style here refers to the performance that is unique to other articles, with a comprehensive overall characteristic.

In some alternative implementations of the present embodiment, the polishing processing includes at least one of: unifying a grammatical style of the generated article; deleting statements inconsistent with preceding and succeeding statements; and replacing the statements inconsistent with preceding and succeeding statements.

In this implementation, the unifying a grammatical style of the generated article may be realized by replacing and transforming specific vocabularies and specific sentence patterns, thereby making the grammatical style of the article consistent. Deleting statements inconsistent with preceding and succeeding statements, or replacing the statements inconsistent with preceding and succeeding statements may both alleviate the incoherence of the statements.

In some alternative implementations of the present embodiment, the inserting rich media data processing includes: extracting rich media data associated with a characteristic of the generated article from a pre-established resource library; and inserting the extracted rich media data into the generated article.

In the present embodiment, the inserting the extracted rich media data into the generated article includes: first searching for rich media data based on at least one of: the topic, the outline, the paragraph abstract and the keyword, then selecting a high-quality rich media database through quality filtering, and ensuring that the inserted rich media data is relatively uniform according to the number of words or the number of paragraphs between images. For example, if there are 1000 words between two images in the article and 10 words between other two images, then the inserted rich media data is not uniform and does not meet the reading habits of the user groups. The rich media data is one or a combination of several forms that may include streaming media, sound, Flash, and programming languages such as Java, Javascript, and dynamic HTML. The rich media data may be applied in a variety of web services, such as website design, email, banner for website pages, buttons, pop-up advertisements, and interstitial advertisements. It should be understood that the rich media data may enhance information, and a more accurate orientation of the information may have better interaction.

In some alternative implementations of the present embodiment, the extracting rich media data associated with a characteristic of the polished article from a pre-established resource library includes: generating a candidate rich media list from the pre-established resource library by extracting rich media data based on at least one of: the article topic, the article outline, abstracts of paragraphs of the polished article, or keywords of the paragraphs of the polished article; and extracting the rich media data associated with the characteristic of the polished article from the candidate rich media list using quality filtering.

In this implementation, a rich media list is generated by extracting rich media data based on at least one of: the article topic, the article outline, the abstracts of paragraphs of the polished article, or keywords of the paragraphs of the polished article. Then, quality filtering is used to extract rich media data associated with the characteristic of the polished article from the rich media list. Therefore, the quality of the rich media data in the resource library may be improved.

In some alternative implementations of the present embodiment, the pre-established resource library may be established by: acquiring a characteristic of the rich media data; and establishing an index structure based on the characteristic of the rich media data, to obtain the resource library.

In some alternative implementations of the present embodiment, the quality filtering may be performed based on at least one of: graphic and textual relevance, image resolution, image aspect ratio, image source authority, advertisement filtering strategy, anti-cheat filtering strategy, anti-vulgar filtering strategy or watermark filtering strategy.

In this implementation, the advertisement filtering strategy may include an advertisement filtering rule and an advertisement filtering model; the anti-cheat filtering strategy may include an anti-cheat filtering rule and an anti-cheat filtering model; the anti-vulgar filtering strategy may include an anti-vulgar filtering rule and an anti-vulgar filtering model; the watermark filtering strategy may include a watermark filtering rule and a watermark filtering model.

In the present embodiment, the typesetting optimization processing may be implemented by using a typesetting optimization method in the prior art or a technology developed in the future, which is not limited in the present disclosure. For example, the typesetting optimization processing may be selecting a content that needs to be highlighted after determining various article contents to be presented, and finally matching an appropriate color layout to obtain an optimized article.

Here, the typesetting optimization processing may also determine a typesetting adapted to the generated article based on an analysis result of article sample data and user behavior data for the article sample data, to obtain the optimized article.

In step 250, inputting the article topic and the article outline into a title model to generate a title of the article.

In the present embodiment, after the generated article is obtained, the article topic and the article outline may be inputted into a title model to generate the topic of the article. The title model here is a function with the article topic and the article outline as the independent variables. When the article topic and the article outline are received, the article topic may be outputted according to the function. For example, it may be a title model that can be learned and obtained by the machine based on the article topic, the article outline, and the title of the article included in the existing article sample, or may be a manually set title model.

In some alternative implementations of the present embodiment, the method further includes: performing an attribute expansion on a core word in the title; and replacing and rewriting the core word in the title after the attribute expansion to obtain an updated title.

In this implementation, the core word in the title may be mined first, then attribute expansion is performed on the core word, and the core word in the title after the attribute expansion is replaced and rewritten to obtain the updated title. For example, for the introduction of Emperor XXX, the core word in the title is mined to be XXX. Then, the obtained attribute of XXX may be that the emperor was born a cowboy. Therefore, the introduction of Emperor XXX may be replaced and rewritten as: who is the emperor born a cowboy?

It should be understood that the above description in FIG. 2 is only an exemplary description of the method for generating an article in the embodiments of the present disclosure, and does not represent a limitation on the present disclosure. For example, the method for generating an article in the embodiments of the present disclosure may not include the above step 240, or may not include the above step 250, thereby obtaining a new method for generating an article. Step 210, step 220, and step 230 in FIG. 2 respectively correspond to step 110, step 120, and step 130 in FIG. 1. Therefore, the operations and features described in FIG. 1 for step 110, step 120, and step 130 are equally applicable to step 210, step 220 and step 230, and detailed descriptions thereof will be omitted.

As compared with the method for generating an article described in FIG. 1, the method for generating an article provided by the above embodiments of the present disclosure adds step 240 and step 250, and according to step 240 and step 250, the optimized generated article and the title of the generated article may be obtained, so that the generated article is more comprehensive and contains more information, the title of the article is more attractive, and the content and title of the article are more adapted to the reading habits of the user groups.

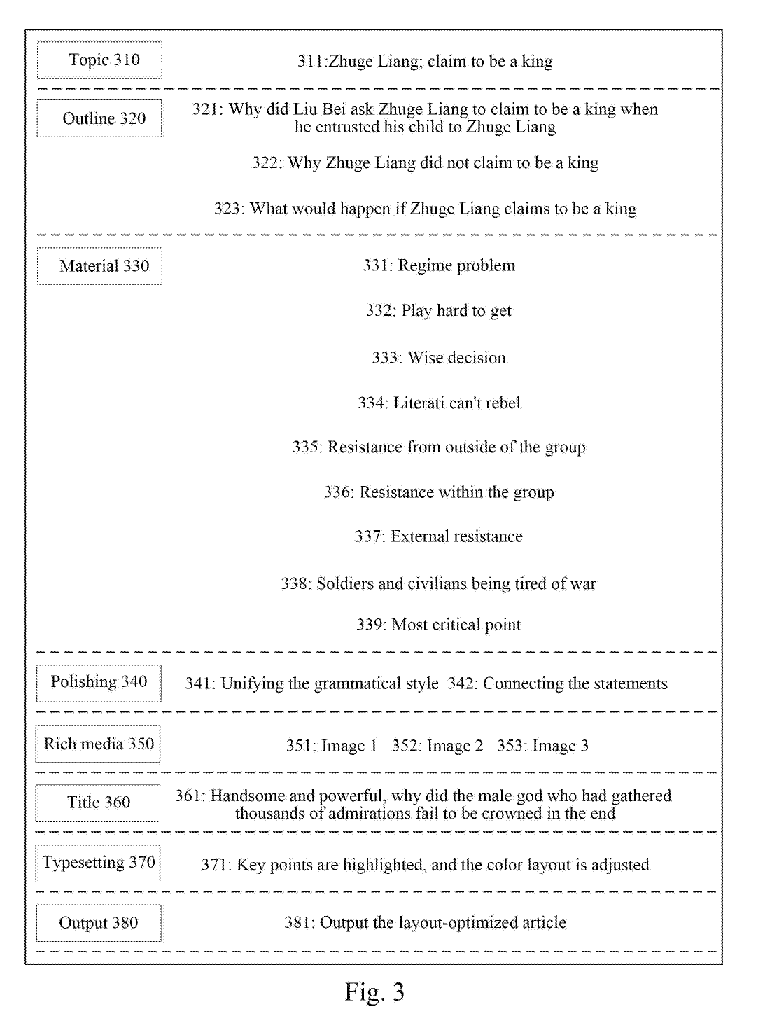

An exemplary application scenario of the method for generating an article of the embodiments of the present disclosure is described below with reference to FIG. 3.

As shown in FIG. 3, according to the method for generating an article of the embodiments of the present disclosure, first, based on a specific embodiment 311 “Zhuge Liang; claim to be a king” of an input article topic 310, a specific embodiment of the article outline 320 may be generated, that is, including outline 321: Why did Liu

Bei ask Zhuge Liang to claim to be a king when he entrusted his child to Zhuge Liang; outline 322: Why Zhuge Liang did not claim to be a king; and outline 323: What would happen if Zhuge Liang claims to be a king. Then, from the pre-established material library, a material 330 associated with the characteristics of the article outlines 321 to 323 is extracted, including the following materials: material 331 “regime problem,” material 332 “play hard to get,” material 333 “wise decision,” material 334 “literati can't rebel,” material 335 “resistance from outside of the group,” material 336 “resistance within the group,” material 337 “external resistance,” material 338 “soldiers and civilians being tired of war” and material 339 “most critical point.” Then, the extracted material 330 (including the materials 331-339) is inserted into the article outline to obtain the generated article. Thereafter, the generated article is polished 340, specifically including in step 341, unifying the grammatical style of the article, and in step 342, connecting the statements to obtain the polished article. Then, from the pre-established resource library, a rich media 350 associated with the characteristic of the polished article is extracted, including an image 1 numbered 351, an image 2 numbered 352, and an image 3 numbered 353. Then, the extracted rich media 350 (including rich media 351-353) is inserted into the polished article to obtain an article inserted with the rich media. Then, in the generation step of a title 360, the article topic and the article outline are inputted into a title model to obtain an initial title, attribute expansion is performed on the core word in the initial title, and the core word in the initial title after the attribute expansion is replaced and rewritten, to obtain an updated title 361 “Handsome and powerful, why did the male god who had gathered thousands of admirations fail to be crowned in the end?” Then, in the processing step of typesetting 370, layout optimization processing is performed on the article inserted with the rich media, for example, a specific operation 371 is performed, the key points are highlighted, and the color layout is adjusted, thereby obtaining a layout-optimized article. Finally, in the processing step of outputting 380, an operation 381 may be specifically performed to output the layout-optimized article.

The method for generating an article provided in the above application scenario of the present disclosure improves the efficiency of generating an article and enriches the content of the article, so that the generated article is consistent in logic and grammatical style, and the form and content of the article is richer and more reasonable, as compared with the prior art.

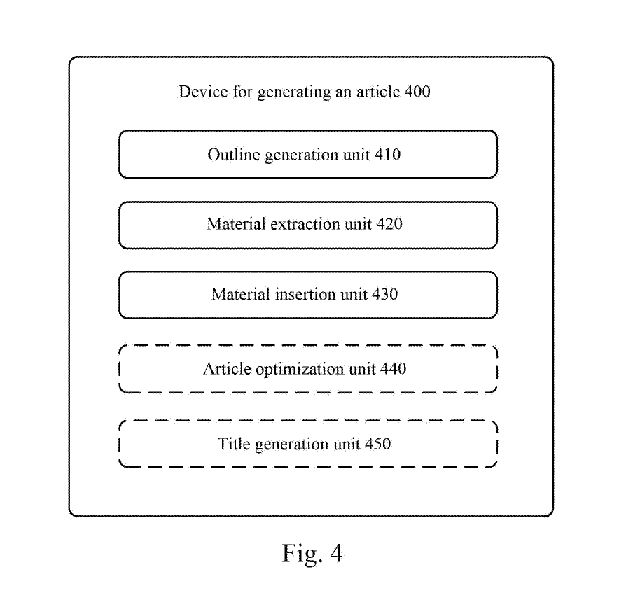

With further reference to FIG. 4, as an implementation of the foregoing method, an embodiment of the present disclosure provides an embodiment of a device for generating an article, and the embodiment of the device for generating an article corresponds to the embodiments of the method for generating an article shown in FIGS. 1 to 3, therefore, the operations and features of the method for generating an article in FIGS. 1 to 3 are equally applicable to the device 400 for generating an article and the units contained therein, and detailed descriptions thereof will be omitted.

As shown in FIG. 4, the device 400 for generating an article includes: an outline generation unit 410, configured to generate an article outline based on an input article topic and at least one of: an outline model, an outline database established based on user behavior data corresponding to the article topic, or a manually set outline; a material extraction unit 420, configured to extract, from a pre-established material library, a material associated with a characteristic of the article outline; and a material insertion unit 430, configured to insert the extracted material into the article outline to obtain a generated article.

In some embodiments, the outline database established based on user behavior data corresponding to the article topic in the outline generation unit includes: retrieving subtopics around the article topic across an entire network, to establish a subtopic database; sorting the subtopics in the subtopic database according to a user's click sequence on the subtopics in the subtopic database and/or a semantic progression sequence of the subtopics in the subtopic database; eliminating subtopics in the subtopic database that do not meet a predetermined logic rule, to obtain subtopics meeting the predetermined logic rule; and defining the subtopics meeting the predetermined logic rule as outlines to obtain the outline database.

In some embodiments, the pre-established material library in the material extraction unit is established by: acquiring a characteristic of the material, where the material is obtained by filtering contents of existing articles according to a filtering rule and/or transforming the contents of the existing articles; and establishing an index structure based on the characteristic of the material, to obtain the material library.

In some embodiments, the device further includes: an article optimization unit 440, configured to perform an optimization processing on the generated article to obtain an optimized generated article, and the optimization processing including at least one of: polishing processing, inserting rich media data processing, or typesetting optimization processing.

In some embodiments, the polishing processing in the article optimization unit includes at least one of: unifying a grammatical style of the generated article; deleting statements inconsistent with preceding and succeeding statements; and replacing the statements inconsistent with preceding and succeeding statements.

In some embodiments, the inserting rich media data processing in the article optimization unit includes: extracting rich media data associated with a characteristic of the generated article from a pre-established resource library; and inserting the extracted rich media data into the generated article.

In some embodiments, the extracting rich media data associated with a characteristic of the generated article from a pre-established resource library in the article optimization unit includes: generating a candidate rich media list from the pre-established resource library by extracting rich media data based on at least one of: the article topic, the article outline, abstracts of paragraphs of the generated article, or keywords of the paragraphs of the generated article; and extracting the rich media data associated with the characteristic of the generated article from the candidate rich media list using quality filtering.

In some embodiments, the pre-established resource library in the article optimization unit is established by: acquiring a characteristic of the rich media data; and establishing an index structure based on the characteristic of the rich media data, to obtain the resource library.

In some embodiments, the quality filtering in the article optimization unit is performed according to at least one of: graphic and textual relevance, image resolution, image aspect ratio, image source authority, advertisement filtering strategy, anti-cheat filtering strategy, anti-vulgar filtering strategy or watermark filtering strategy.

In some embodiments, the device further includes: a title generation unit 450, configured to input the article topic and the article outline into a title model to obtain a title of the generated article.

In some embodiments, the device further includes: an attribute expansion unit (not shown in the figure), configured to perform an attribute expansion on a core word in the title; and a title updating unit (not shown in the figure), configured to replace and rewrite the core word in the title after the attribute expansion to obtain an updated title.

The present disclosure further provides an embodiment of a device, including: one or more processors; and a storage apparatus, for storing one or more programs, the one or more programs, when executed by the one or more processors, cause the one or more processors to implement the method for generating an article according to any one of the embodiments.

The present disclosure further provides an embodiment of a computer readable storage medium, storing a computer program thereon, the computer program, when executed by a processor, implements the method for generating an article according to any one of the embodiments.

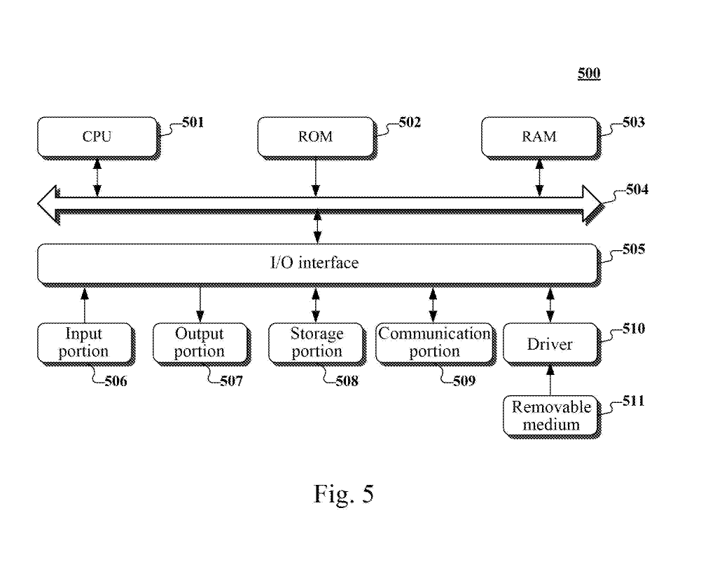

With further reference to FIG. 5, a schematic structural diagram of a computer system 500 adapted to implement a terminal device or server of the embodiments of the present disclosure is shown. The terminal device shown in FIG. 5 is merely an example, and should not impose any limitation on the function and scope of use of the embodiments of the present disclosure.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 603 from a storage portion 508. The RAM 603 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: an input portion 506 including a keyboard, a mouse, etc.; an output portion 507 including such as a cathode ray tube (CRT), a liquid crystal display device (LCD), a speaker, etc.; a storage portion 508 including a hard disk and the like; and a communication portion 509 including a network interface card, such as a LAN card and a modem. The communication portion 509 performs communication processes via a network, such as the Internet. A driver 510 is also connected to the I/O interface 505 as required. A removable medium 511, such as a magnetic disk, an optical disk, a magneto-optical disk, and a semiconductor memory, may be installed on the driver 510, to facilitate the retrieval of a computer program from the removable medium 511, and the installation thereof on the storage portion 508 as needed.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication portion 509, and/or may be installed from the removable medium 511. The computer program, when executed by the central processing unit (CPU) 501, implements the above mentioned functionalities as defined by the method of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the present disclosure, the computer readable storage medium may be any physical medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a unit, a program segment, or a code portion, said unit, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in the embodiments of the present disclosure may be implemented by means of software or hardware. The described units may also be provided in a processor, for example, described as: a processor, including an outline generation unit, a material extraction unit, and a material insertion unit. Here, the names of these units do not in some cases constitute a limitation to such units themselves. For example, the outline generation unit may also be described as “a unit for generating an article outline based on an input article topic and an outline generation strategy.”

In another aspect, the present disclosure further provides a non-volatile computer storage medium. The non-volatile computer storage medium may be included in the device in the above described embodiments, or a stand-alone non-volatile computer storage medium not assembled into the terminal. The non-volatile computer storage medium stores one or more programs. The one or more programs, when executed by a device, cause the device to: generate an article outline based on an input article topic and at least one of: an outline model, an outline database established based on user behavior data corresponding to the article topic, or a manually set outline; extract, from a pre-established material library, a material associated with a characteristic of the article outline; and insert the extracted material into the article outline to obtain a generated article.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

What is claimed is:

1. A method for generating an article, the method comprising:
generating an article outline based on an input article topic and at least one of: an outline model, an outline database established based on user behavior data corresponding to the article topic, or a manually set outline;
extracting, from a pre-established material library, a material associated with a characteristic of the article outline; and
inserting the extracted material into the article outline to obtain a generated article.

2. The method according to claim 1, wherein the outline database is established based on user behavior data corresponding to the article topic by:
retrieving subtopics around the article topic across an entire network, to establish a subtopic database;
sorting the subtopics in the subtopic database according to a user's click sequence on the subtopics in the subtopic database and/or a semantic progression sequence of the subtopics in the subtopic database;
eliminating subtopics in the subtopic database that do not meet a predetermined logic rule, to obtain subtopics meeting the predetermined logic rule; and
defining the subtopics meeting the predetermined logic rule as outlines to obtain the outline database.

3. The method according to claim 1, wherein the pre-established material library is established by:
acquiring a characteristic of the material, wherein the material is obtained by filtering contents of existing articles according to a filtering rule and/or transforming the contents of the existing articles; and
establishing an index structure based on the characteristic of the material, to obtain the material library.

4. The method according to claim 1, wherein the method further comprises: performing optimization processing on the generated article to obtain an optimized generated article, and the optimization processing comprising at least one of: polishing processing, inserting rich media data processing, or typesetting optimization processing.

5. The method according to claim 4, wherein the polishing processing comprises at least one of: unifying a grammatical style of the generated article; deleting statements inconsistent with preceding and succeeding statements; and replacing the statements inconsistent with preceding and succeeding statements.

6. The method according to claim 4, wherein the inserting rich media data processing comprises:
extracting rich media data associated with a characteristic of the generated article from a pre-established resource library; and
inserting the extracted rich media data into the generated article.

7. The method according to claim 6, wherein the extracting rich media data associated with a characteristic of the generated article from a pre-established resource library comprises:
generating a candidate rich media list from the pre-established resource library by extracting rich media data based on at least one of: the article topic, the article outline, abstracts of paragraphs of the generated article, or keywords of the paragraphs of the generated article; and
extracting the rich media data associated with the characteristic of the generated article from the candidate rich media list using quality filtering.

8. The method according to claim 6, wherein the pre-established resource library is established by:
acquiring a characteristic of the rich media data; and
establishing an index structure based on the characteristic of the rich media data, to obtain the resource library.

9. The method according to claim 7, wherein the quality filtering is performed according to at least one of:
graphic and textual relevance, image resolution, image aspect ratio, image source authority, advertisement filtering strategy, anti-cheat filtering strategy, anti-vulgar filtering strategy or watermark filtering strategy.

10. The method according to claim 1, wherein the method further comprises:
inputting the article topic and the article outline into a title model to obtain a title of the generated article.

11. The method according to claim 10, wherein the method further comprises:
performing an attribute expansion on a core word in the title; and
replacing and rewriting the core word in the title after the attribute expansion to obtain an updated title.

12. A device for generating an article, the device comprising:
at least one processor; and
a memory storing instructions, the instructions when executed by the at least one processor, cause the at least one processor to perform operations, the operations comprising:
generating an article outline based on an input article topic and at least one of: an outline model, an outline database established based on user behavior data corresponding to the article topic, or a manually set outline;
extracting, from a pre-established material library, a material associated with a characteristic of the article outline; and
inserting the extracted material into the article outline to obtain a generated article.

13. The device according to claim 12, wherein the outline database is established based on user behavior data corresponding to the article topic by:
retrieving subtopics around the article topic across an entire network, to establish a subtopic database;
sorting the subtopics in the subtopic database according to a user's click sequence on the subtopics in the subtopic database and/or a semantic progression sequence of the subtopics in the subtopic database;
eliminating subtopics in the subtopic database that do not meet a predetermined logic rule, to obtain subtopics meeting the predetermined logic rule; and
defining the subtopics meeting the predetermined logic rule as outlines to obtain the outline database.

14. The device according to claim 12, wherein the pre-established material library is established by:
acquiring a characteristic of the material, wherein the material is obtained by filtering contents of existing articles according to a filtering rule and/or transforming the contents of the existing articles; and
establishing an index structure based on the characteristic of the material, to obtain the material library.

15. The device according to claim 12, wherein the operations further comprise:
performing optimization processing on the generated article to obtain an optimized generated article, and the optimization processing comprising at least one of: polishing processing, inserting rich media data processing, or typesetting optimization processing.

16. The device according to claim 15, wherein the polishing processing comprises at least one of: unifying a grammatical style of the generated article; deleting statements inconsistent with preceding and succeeding statements; and replacing the statements inconsistent with preceding and succeeding statements.

17. The device according to claim 15, wherein the inserting rich media data processing comprises:
extracting rich media data associated with a characteristic of the generated article from a pre-established resource library; and
inserting the extracted rich media data into the generated article.

18. The device according to claim 17, wherein the extracting rich media data associated with a characteristic of the generated article from a pre-established resource library comprises:
generating a candidate rich media list from the pre-established resource library by extracting rich media data based on at least one of: the article topic, the article outline, abstracts of paragraphs of the generated article, or keywords of the paragraphs of the generated article; and
extracting the rich media data associated with the characteristic of the generated article from the candidate rich media list using quality filtering.

19. The device according to claim 17, wherein the pre-established resource library is established by:
acquiring a characteristic of the rich media data; and
establishing an index structure based on the characteristic of the rich media data, to obtain the resource library.

20. The device according to claim 18, wherein the quality filtering is performed according to at least one of:
graphic and textual relevance, image resolution, image aspect ratio, image source authority, advertisement filtering strategy, anti-cheat filtering strategy, anti-vulgar filtering strategy or watermark filtering strategy.

21. The device according to claim 12, wherein the operations further comprise:
inputting the article topic and the article outline into a title model to obtain a title of the generated article.

22. The device according to claim 21, wherein the operations further comprise:
performing an attribute expansion on a core word in the title; and
replacing and rewriting the core word in the title after the attribute expansion to obtain an updated title.

23. A non-transitory computer readable storage medium, storing a computer program thereon, the computer program, when executed by a processor, causes the processor to perform operations, the operations comprising:
generating an article outline based on an input article topic and at least one of: an outline model, an outline database established based on user behavior data corresponding to the article topic, or a manually set outline;
extracting, from a pre-established material library, a material associated with a characteristic of the article outline; and
inserting the extracted material into the article outline to obtain a generated article.
